(19) United States
(12) Patent Application Publication
(10) Pub. No.: US 2017/0061533 A1
(43) Pub. Date: Mar. 2, 2017

(54) METHOD AND DEVICE FOR SECURITY ASSESSMENT

(71) Applicant: Xiaomi Inc., Beijing (CN)

(72) Inventors: Shuai Chen, Beijing (CN); Tiejun Liu, Beijing (CN); Xiangyang Zhang, Beijing (CN)

(21) Appl. No.: 15/152,532

(22) Filed: May 11, 2016

(30) Foreign Application Priority Data
Aug. 31, 2015 (CN) 201510546508.6

(51) Int. Cl. G06Q 40/02; H04L 29/06

(52) U.S. Cl. CPC G06Q 40/025; H04L 63/1433; H04L 63/20

(57) ABSTRACT

A method and a device for security assessment are provided. The method includes: acquiring a user record of a user, the user record including an identity, position information, recording time and credit information of the user; determining a region where the user locates according to the position information in the user record; acquiring user records of all users in the region; calculating a level of security of the region according to the user records of all the users in the region; and sending the level of security to the user.

### CROSS-REFERENCE TO RELATED APPLICATIONS

This application is based upon and claims priority to Chinese Patent Application 201510546508.6, filed Aug. 31, 2015, the entire contents of which are incorporated herein by reference.

### TECHNICAL FIELD

The present disclosure relates to field of communications, and more particularly, to a method and a device for security assessment.

### BACKGROUND

With the development and progress of urbanization, some large and medium-sized cities are usually composed of a plurality of urban regions. Each region forms respective residential areas and business areas. With the improvement of the living standards of people, the level of security of the region where everyone locates becomes the top issue for people.

### SUMMARY

The present disclosure provides a method and a device for security assessment.

According to a first aspect of embodiments of the present disclosure, there is provided a method for security assessment, including: acquiring a user record of a user, the user record including an identity, position information, recording time and credit information of the user; determining a region where the user locates according to the position information in the user record; acquiring user records of all users in the region; calculating a level of security of the region according to the user records of all the users in the region; and sending the level of security to the user.

According to a second aspect of embodiments of the present disclosure, there is provided a device for security assessment, including: a processor; and a memory for storing instructions executable by the processor; wherein the processor is configured to: acquire a user record of a user, the user record including an identity, position information, recording time and credit information of the user; determine a region where the user locates according to the position information in the user record; acquire user records of all users in the region; calculate the level of security of the region according to the user records of all the users in the region; and send the level of security to the user.

According to a third aspect of the embodiments of the present disclosure, there is provided a non-transitory computer-readable storage medium including instructions, executable by a processor in a server or a base station, for performing a method for security assessment, the method including: acquiring a user record of a user, the user record comprising an identity, position information, recording time and credit information of the user; determining a region where the user locates according to the position information in the user record; acquiring user records of all users in the region; calculating a level of security of the region according to the user records of all the users in the region; and sending the level of security to the user.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is an application scenario, according to an exemplary embodiment.

FIG. 2 is a flow chart of a method for security assessment, according to an exemplary embodiment.

FIG. 3 is a flow chart of a method for security assessment, according to an exemplary embodiment.

FIG. 4 is a block diagram of a device for security assessment, according to an exemplary embodiment.

FIG. 5 is a block diagram of a device for security assessment, according to an exemplary embodiment.

FIG. 6 is a block diagram of a device for security assessment, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

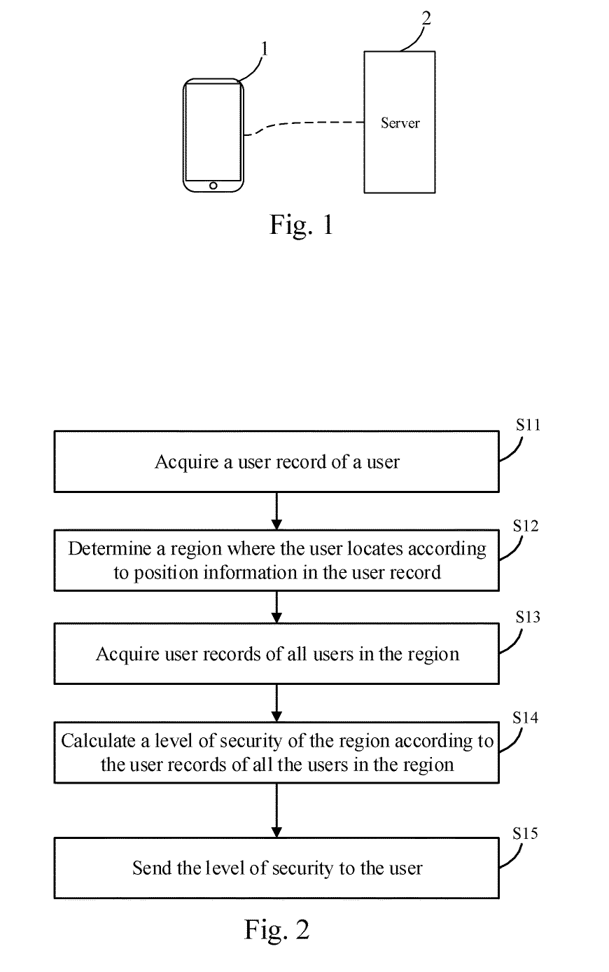

In order to facilitate description of embodiments, an application scenario of the embodiments in the present disclosure is simply introduced hereinafter. Referring to FIG. 1, the scenario scene includes a terminal device 1 and a server 2, wherein the terminal device 1 and the server 2 are wirelessly connected. The terminal device 1 includes, but is not limited to, devices such as a smart mobile phone, and a smart phone. The server 2 is configured to determine a level of security of a given region, and then send the level of security to the terminal device 1 of a user in the given region, thus playing a role of reminding and protecting the user. The server 2 may also be other devices, for example, a base station, and a device integrated in the server or in the base station.

It should be illustrated that the foregoing device categories are exemplary only, and are not restricted by the present disclosure.

FIG. 2 is a flow chart of a method for security assessment, according to an exemplary embodiment. As shown in FIG. 2, the method is applicable to the forgoing server or base station, including the following steps.

In step S11, a user record of a user is acquired, the user record including an identity, position information, recording time and credit information of the user.

The identity of the user may be an IMEI (International Mobile Equipment Identity) of a terminal device of the user, an account number of the user, or the like. The position information may be represented by a GPS (Global Positioning System), or may be represented by a position of a base station or a WIFI (Wireless Fidelity) hotspot to which the terminal device of the user accesses. The credit information is personal credit information collected, collated and saved by a personal credit database established by a specific authority, and is used to provide credit report querying services for commercial banks and individuals, and provide relevant information services for monetary policy making, financial regulation and other functions set forth in laws and regulations.

In step S12, a region where the user locates is determined according to the position information in the user record.

In the present disclosure, one city or a bigger (or smaller) district may be divided into a plurality of regions, and the region where the user locates is one of the plurality of regions. The region may be divided according to the administrative region or be divided according to other manners, for example, be divided according to the business area. Because the business area has relatively concentrated population and strong liquidity, the effect of the security assessment in the present disclosure may be exerted to the maximum extent through dividing the region according to the business area.

In step S13, user records of all users in the region are acquired.

In step S14, a level of security of the region is calculated according to the user records of all the users in the region.

In step S15, the level of security is sent to the user.

The present disclosure determines the region where the user locates according to the user record, then calculates the level of security of the region according to user records of all users in the region, and sends the level of security to the user, thus solving the problem that the prior art cannot determine the level of security of the region where the user locates, and improving the security index of daily life of the user.

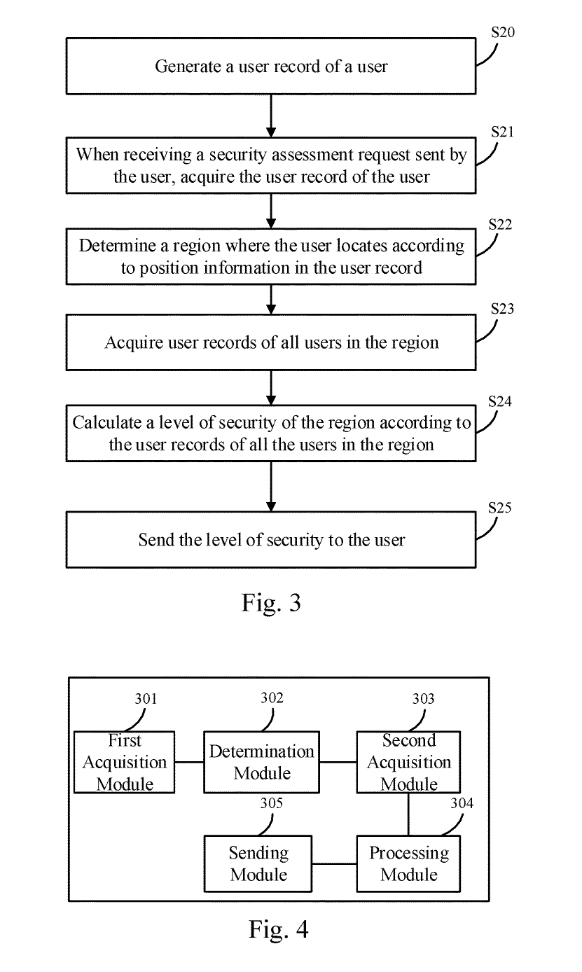

FIG. 3 is a flow chart of a method for security assessment, according to an exemplary embodiment. As shown in FIG. 3, the method is applicable to the foregoing server or base station, including the following steps.

In step S20, a user record of a user is acquired, the user record including an identity, position information, recording time and credit information of the user.

The identity of the user may be an IMEI of a terminal device of the user, an account number of the user, or the like. The position information may be represented by a GPS, or may be represented by a position of a base station or a WIFI hotspot to which the terminal device of the user accesses. The credit information is personal credit information collected, collated and saved by a personal credit database established by a specific authority, and is used to provide credit report querying services for commercial banks and individuals, and provide relevant information services for monetary policy making, financial regulation and other functions set forth in laws and regulations.

In the present embodiment, the generating the user record of the user may include: acquiring the user information of the user, the user information including an identity, position information, and time corresponding to the position information of the user; and querying credit information of the user from a credit server according to the identity of the user; and generating the user record according to the identity, the position information, the time corresponding to the position information and the credit information of the user, the recording time in the user record being the time corresponding to the position information.

The credit server may be a server of a third party credit web site, the third party credit website is a website specially engaged in work of collecting, collating and analyzing enterprise and personal credit information, for example, Sesame Credit, and Xiaomi Credit.

The user record is simply and conveniently generated using the foregoing manner; moreover, and subsequent calculation demands may be ensured.

In the present embodiment, acquiring the user record of the user may include: receiving the user information sent by the terminal device of the user, the position information in the user information being GPS information.

Alternatively, acquiring the user record of the user may include: receiving the user information sent by an operator, the position information in the user information being the base station or WIFI hotspot to which the terminal device of the user accesses.

Alternatively, acquiring the user record of the user may include: acquiring the user information from an operator server periodically, the position information in the user information being the base station or WIFI hotspot to which the terminal device of the user accesses.

In step S21, when receiving a security assessment request sent by the user, the user record of the user is acquired, the security assessment request being configured to acquire the level of security of the region.

In other embodiments, the user may launch a security assessment service for the server. After the user launches the security assessment service, the server periodically acquires the user record of the user and carries out subsequent steps. The security assessment service is configured to periodically acquire the level of security of the region.

In step S22, a region where the user locates is determined according to the position information in the user record.

In the present disclosure, one city or a bigger (or smaller) district may be divided into a plurality of regions, and the region where the user locates is one of the plurality of regions. The region may be divided according to the administrative region or be divided according to other manners, for example, be divided according to the business area. Because the business area has relatively concentrated population and strong liquidity, the effect of the security assessment in the present disclosure may be exerted to the maximum extent through dividing the region according to the business area.

In step S23, user records of all users in the region are acquired.

Because the foregoing step S20 may be repeatedly performed for different users, a large number of user records may be generated, and the generated user records will be stored in the server. In step S23, the server finds the user records of all the users located in the region according to the position information and then acquires these user records.

In other embodiments, when acquiring the user record, recording time also needs to be considered except screening the position information, i.e., only partial user records of the region are acquired. For example, the user records of the region having the recording time within a preset range are acquired, wherein the present range may be one month, one week, or the like.

In step S24, the level of security of the region is calculated according to the user records of all the users in the region.

In an implementation manner of the embodiment, calculating the level of security of the region according to the user records of all the users in the region may include: calculating a security factor of the region according to the user records of all the users in the region, the security factor being configured to characterize the level of security of the region; sorting the security factor of the region and security factors of a plurality of preset regions in a descending order, the plurality of preset regions being regions within a preset range of the region where the user locates; and when the security factor of the region where the user locates is one of the top N security factors, determining that the level of security of the region where the user locates is low; and when the security factor of the region where the user locates is one of the last M security factors, determining that the level of security of the region where the user locates is high, M and N being positive integers.

The preset range may be divided by district or by distance, for example, a region which is in the same district as the region where the user locates, or within 10 km from the region where the user locates.

When a city or an urban area includes more regions, the foregoing manner may be employed to calculate the level of security of the region. This calculation method selects regions with high and low degrees of security according to the ordering positions of the security factors, which may remind the user of the relative level of security of the region in the entire city or urban area.

For example, security factors in four regions A, B, C and D of city I are 90, 70, 68 and 50 respectively, and the descending order of the security factors is: A, B, C, D. The top 1 (i.e., the foregoing N) region among the four regions is selected as the region with low level of security, i.e., region A; and the last 3 (i.e., the foregoing M) regions among the four regions are selected as the regions with high degrees of security, i.e., regions B, C and D. Certainly, in the present embodiment, the level of security of the region may be divided into more levels except employing high and low levels to represent the level of security of the region, for example, excellent, good, middle and poor, which are exemplary only and not restrictive of the present disclosure.

Moreover, in the foregoing implementation manner, the security factors may also be sorted in an ascending order.

In another implementation manner of the present embodiment, calculating the level of security of the region according to the user records of all the users in the region may include: calculating a security factor of the region according to the user records of all the users in the region; and when the security factor of the region is greater than a preset value, determining that the level of security of the region is low, and when the security factor of the region is less than or equal to the preset value, determining that the level of security of the region is high.

Compared with the previous manner, this manner is to calculate an absolute level of security, which has a stronger warning effect. The preset value may be set according to actual needs.

For example, in four regions A, B, C and D of city I, the security factors are 90, 70, 68 and 50 respectively, wherein the preset value is 75, then the region A is determined to be the region with low level of security, and the regions B, C and D are determined to be the regions with high level of security.

In the foregoing two implementation manners, calculating the security factor of the given region according to user records in the given region may include: finding out bad credit records from the user records of all the users in the region; and calculating the security factor of the region according to the found bad credit records.

The bad credit record is also called a bad faith record (blemished credit), for example, a bank customer has a late repayment record due to some reasons after applying a loan; at this moment the credit information in the user record is namely a bad credit record.

In the foregoing implementation manner, the security factor of the region is determined by using the credit information. The credit information is used for judging the credibility of one person all the time, while the person with lower credibility usually has higher criminal probability, and the level of security of the region where the user locates is determined by all the users active in the region; therefore, the accuracy of determining the level of security by finding out the bad credit records from the user records of all the users in the region is high.

In embodiments of the present disclosure, the manner identical to that of the region is also employed in a plurality of preset regions for calculating the security, which will not be elaborated herein.

The calculating the security factor of the region according to the found bad credit records may include: acquiring recording time of each of the bad credit records; determining a coefficient corresponding to the recording time of the bad credit record, the coefficient corresponding to the recording time changing from small to big with the recording time being closer to the current time; and calculating a sum of the coefficients corresponding to the recording time of the found bad credit records to obtain the security factor of the region.

For example, there are 100 bad credit records among the user records of all the users in the region D, wherein the recording time of 50 bad credit records is 5 hours ago, the recording time of 25 bad credit records is 1 hour ago, and the recording time of 25 bad credit records is within 1 hour. Accordingly, the coefficients corresponding to the recording time (5 hours ago, 1 hour ago and 1 hour) are respectively 0.2, 0.6 and 1; therefore, the security factor=50*0.2+25*0.6+25*1=50. Certainly, the coefficients corresponding to the recording time herein are exemplary only and are not restrictive of the present disclosure.

In addition, during calculation, the coefficient corresponding to the recording time of the bad credit record is employed for calculation. The farther the recording time from the current time is, the less the probability of the user still in a given region currently is, and therefore the smaller the influence on the level of security is. This calculation method is similarly beneficial for improving the accuracy of the level of security.

In step S25, the level of security is sent to the user.

The above-mentioned step of sending the level of security to the user may include: pushing the level of security of the given region to the terminal device of the user in a form of short message or in other message forms.

In other embodiments, the level of security may be judged before conducting the step S25, and the level of security is sent to the user only when the level of security is low, thus reminding the user of self-protection.

The present disclosure determines the region where the user locates according to the user record, then calculates the level of security of the region according to user records of all users in the region, and sends the level of security to the user, thus solving the problem that the prior art cannot determine the level of security of the region where the user locates, and improving the security index of daily life of the user.

FIG. 4 is a block diagram of a device for security assessment, according to an exemplary embodiment. As shown in FIG. 4, the device may be a server or a base station, and may also be a device integrated in the server or in the base station. The device includes: a first acquisition module 301, a determination module 302, a second acquisition module 303, a processing module processing module 304, and a sending module 305.

The first acquisition module 301 is configured to acquire a user record of a user, the user record including an identity of the user, position information, recording time and credit information.

The identity of the user may be an IMEI of a terminal device of the user, an account number of the user, or the like. The position information may be represented by a GPS, or may be represented by a position of a base station or a WIFI hotspot to which the terminal device of the user accesses. The credit information is personal credit information collected, collated and saved by a personal credit database established by a specific authority, and is used to provide credit report querying services for commercial banks and individuals, and provide relevant information services for monetary policy making, financial regulation and other functions set forth in laws and regulations.

The determination module 302 is configured to determine a region where the user locates according to the position information in the user record.

In the present disclosure, one city or a bigger (or smaller) district may be divided into a plurality of regions, and the region where the user locates is one of the plurality of regions. The region may be divided according to the administrative region or be divided according to other manners, for example, be divided according to the business area. Because the business area has relatively concentrated population and strong liquidity, the effect of the security assessment in the present disclosure may be exerted to the maximum extent through dividing the region by the business area.

The second acquisition module 303 is configured to acquire user records of all the users in the region.

The processing module processing module 304 is configured to calculate a level of security of the region according to the user records of all the users in the region.

The sending module 305 is configured to send the level of security to the user.

The present disclosure determines the region where the user locates according to the user record, then calculates the level of security of the region according to user records of all users in the region, and sends the level of security to the user, thus solving the problem that the prior art cannot determine the level of security of the region where the user locates, and improving the security index of daily life of the user.

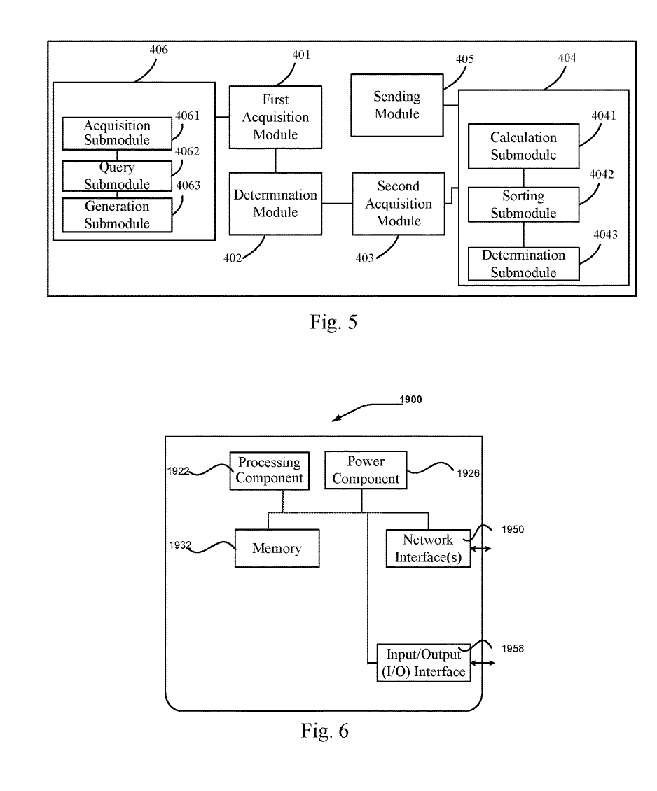

FIG. 5 is a block diagram of another device for security assessment, according to an exemplary embodiment. As shown in FIG. 5, the device may be a server or a base station, and may also be a device integrated in the server or in the base station. The device includes: a first acquisition module 401, a determination module 402, a second acquisition module 403, a processing module processing module 404, and a sending module 405.

The first acquisition module 401 is configured to acquire a user record of a user, the user record including an identity of the user, position information, recording time and credit information.

The identity of the user may be an IMEI of a terminal device of the user, an account number of the user, or the like. The position information may be represented by a GPS, or may be represented by a position of a base station or a WIFI hotspot to which the terminal device of the user accesses. The credit information is personal credit information collected, collated and saved by a personal credit database established by a specific authority, and is used to provide credit report querying services for commercial banks and individuals, and provide relevant information services for monetary policy making, financial regulation and other functions set forth in laws and regulations.

The determination module 402 is configured to determine a region where the user locates according to the position information in the user record.

In the present disclosure, one city or a bigger (or smaller) district may be divided into a plurality of regions, and the region where the user locates is one of the plurality of regions. The region may be divided according to the administrative region or be divided according to other manners, for example, be divided according to the business area. Because the business area has relatively concentrated population and strong liquidity, the effect of the security assessment in the present disclosure may be exerted to the maximum extent through dividing the region by the business area.

The second acquisition module 403 is configured to acquire user records of all the users in the region.

The processing module processing module 404 is configured to calculate a level of security of the region according to the user records of all the users in the region.

The sending module 405 is configured to send the level of security to the user.

In an implementation manner embodiments of the present disclosure, the processing module 404 includes the following submodules.

A calculation submodule 4041 is configured to calculate the security factor of the region according to the user records of all the users in the region, the security factor being configured to characterize the level of security of the region.

A sorting submodule 4042 is configured to sort the security factor of the region and security factors of a plurality of preset regions in a descending order, the plurality of preset regions being regions within a preset range of the region where the user locates.

A determination submodule 4043 is configured to, when the security factor of the region where the user locates is one of the top N security factors, determine that the security factor of the region where the user locates is low; and when the security factor of the region where the user locates is one of the last M security factors, determine that the level of security of the region where the user locates is high, M and N being positive integers.

The preset range may be divided by district or by distance, for example, a region which is in the same district as the region where the user locates, or within 10 km of the region where the user locates.

When a city or an urban area includes more regions, the foregoing manner may be employed to calculate the level of security of the region where the user locates. This calculation method selects regions with high and low degrees of security according to the ordering positions of the security factors, which may remind the user of the relative level of security of the region in the entire city or urban area.

For example, in four regions A, B, C and D of city I, their security factors are 90, 70, 68 and 50 respectively, and the descending order of the security factors is: A, B, C, D. The top 1 (i.e., the foregoing N) region among the four regions is selected as the region with low level of security, i.e., region A; and the last 3 (i.e., the foregoing M) regions among the four regions are selected as the regions with high degrees of security, i.e., regions B, C and D. Certainly, in the present embodiment, the level of security of the region may be divided into more levels except employing high and low levels to represent the level of security of the region, for example, excellent, good, middle and poor, which are exemplary only and not restrictive of the present disclosure.

Moreover, in the foregoing implementation manner, the security factors may also be sorted in an ascending order.

In another implementation manner of embodiments of the present disclosure, the processing module 404 includes the following submodules.

A calculation submodule 4041 is configured to calculate the security factor of the region according to the user records of all the users in the region, the security factor being configured to characterize the level of security of the region.

A determination submodule 4043 is configured to, when the security factor of the region is greater than a preset value, determine that the level of security of the region is low, and when the region of security factor is less than or equal to the preset value, determine that the level of security of the region is high.

Compared with the previous manner, this manner is to calculate an absolute level of security, which has a stronger warning effect. The preset value may be set according to actual needs.

For example, in four regions A, B, C and D of city I, the security factors are 90, 70, 68 and 50 respectively, wherein the preset value is 75, then the region A is determined to be the region with low level of security, and the regions B, C and D are determined to be the regions with high level of security.

In the foregoing two implementation manners, the calculation submodule 4041 is specifically configured to: find out bad credit records from the user records of all the users in the region; and calculate the security factor of the region according to the found bad credit records.

The bad credit record is also called a bad faith record (blemished credit), for example, a bank customer has a late repayment record due to some reasons after applying a loan; at this moment the credit information in the user record is namely a bad credit record.

In embodiments of the present disclosure, the manner identical to that of the region is also employed in a plurality of preset regions for calculating the security, which will not be elaborated herein. Further, the calculation submodule 4041 is specifically configured to: acquire the recording time of each of the bad credit records; determine a coefficient corresponding to the recording time of the bad credit record, the coefficient corresponding to the recording time changing from small to big with the recording time being closer to the current time; and calculate a sum of the coefficients corresponding to the recording time of the bad credit records found out to obtain the security factor of the region.

For example, there are 100 bad credit records among the user records of all the users in the region D, wherein the recording time of 50 bad credit records is 5 hours ago, the recording time of 25 bad credit records is 1 hour ago, and the recording time of 25 bad credit records is within 1 hour. Accordingly, the coefficients corresponding to the recording times (5 hours ago, 1 hour ago and within 1 hour) are respectively 0.2, 0.6 and 1; therefore, the security factor=50*0.2+25*0.6+25*1=50. Certainly, the coefficients corresponding to the recording time herein are exemplary only and are not restrictive of the present disclosure.

In addition, during calculation, the coefficient corresponding to the recording time of the bad credit record is employed for calculation. The farther the recording time from the current time is, the less the probability of the user still in a given region currently is, and therefore, the smaller the influence on the level of security is. This calculation method is similarly beneficial for improving the accuracy of the level of security.

In embodiments of the present disclosure, the first acquisition module 401 is specifically configured to: when receiving a security assessment request sent by the user, acquire the user record of the user, the security assessment request being configured to acquire the level of security of the region.

In other embodiments, the user may launch a security assessment service for the server. After the user launches the security assessment service, the first acquisition module 401 may periodically acquires the user record of the user. The security assessment service is configured to periodically acquire the level of security of the region.

Moreover, the device further includes: a generation module 406 configured to generate the user record of the user.

The generation module 406 includes: an acquisition submodule 4061 configured to acquire the user information of the user, the user information including an identity of the user, position information, and time corresponding to the position information; a query submodule 4062 configured to query the credit information of the user from a credit server according to the identity of the user; and a generation submodule 4063 configured to generate the user record according to the identity of the user, the position information, the time corresponding to the position information and the credit information, the recording time in the user record being the time corresponding to the position information.

The credit server may be a server of a third party credit website, the third party credit website is specially engaged in work of collecting, collating and analyzing enterprise and personal credit information, for example, Sesame Credit, and Xiaomi Credit.

The user record is simply and conveniently generated using the foregoing manner; moreover, subsequent calculation demands may be ensured.

In the present embodiment, the acquisition submodule 4061 may be specifically configured to receive the user information sent by the terminal device of the user, the position information in the user information being GPS information; or receive the user information sent by an operator, the position information in the user information being the base station or WIFI hotspot to which the terminal device of the user accesses; or, acquire the user information from an operator server periodically, the position information in the user information being the base station or WIFI hotspot to which the terminal device of the user accesses.

In embodiments of the present disclosure, the sending module 405 is specifically configured to push the level of security of the given region to the terminal device of the user by short message or other message forms.

The present disclosure determines the region where the user locates according to the user record, then calculates the level of security of the region according to user records of all users in the region, and sends the level of security to the user, thus solving the problem that the prior art cannot determine the level of security of the region where the user locates, and improving the security index of daily life of the user.

With respect to the devices in the above embodiments, the specific manners for performing operations for individual modules therein have been described in detail in the embodiments regarding the methods, which will not be elaborated herein.

FIG. 6 is a block diagram of a device 1900 for security assessment, according to an exemplary embodiment. For example, the device 1900 may be provided as a server. Referring to FIG. 6, the device 1900 includes a processing component 1922 that further includes one or more processors, and memory resources represented by a memory 1932 for storing instructions executable by the processing component 1922, such as application programs. The application programs stored in the memory 1932 may include one or more modules each corresponding to a set of instructions. Further, the processing component 1922 is configured to execute the instructions to perform the above methods for security assessment.

The device 1900 may also include a power component 1926 configured to perform power management of the device 1900, wired or wireless network interface(s) 1950 configured to connect the device 1900 to a network, and an input/output (I/O) interface 1958. The device 1900 may operate based on an operating system stored in the memory 1932, such as Windows Server™, Mac OS X™, Unix™, Linux™, FreeBSD™, or the like.

In exemplary embodiments, there is also provided a non-transitory computer-readable storage medium including instructions, such as included in the memory 1932, executable by the processor in the device 1900, for performing the above-described methods. For example, the non-transitory computer-readable storage medium may be a ROM, a RAM, a CD-ROM, a magnetic tape, a floppy disc, an optical data storage device, and the like.

A non-transitory computer readable storage medium, when an instruction in the storage medium is performed by a processor of a device, enables the device to perform the above methods for security assessment.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for security assessment, comprising:
acquiring a user record of a user, the user record comprising an identity, position information, recording time and credit information of the user;
determining a region where the user locates according to the position information in the user record;
acquiring user records of all users in the region;
calculating a level of security of the region according to the user records of all the users in the region; and
sending the level of security to the user.

2. The method according to claim 1, wherein the calculating the level of security of the region according to the user records of all the users in the region comprises:
calculating a security factor of the region according to the user records of all the users in the region, the security factor being for characterizing the level of security of the region;
sorting the security factor of the region where the user locates and security factors of a plurality of preset regions in a descending order, the plurality of preset regions being regions within a preset range of the region where the user locates;
when the security factor of the region where the user locates is one of the top N security factors, determining that the level of security of the region where the user locates is low; and
when the security factor of the region where the user locates is one of the last M security factors, determining that the level of security of the region where the user locates is high, M and N being positive integers.

3. The method according to claim 1, wherein the calculating the level of security of the region according to the user records of all the users in the region comprises:
calculating a security factor of the region according to the user records of all the users in the region, the security factor being for characterizing the level of security of the region;
when the security factor of the region is greater than a preset value, determining that the level of security of the region is low; and
when the region of security factor is less than or equal to the preset value, determining that the level of security of the region is high.

4. The method according to claim 2, wherein the calculating the security factor of the region according to the user records of all the users in the region comprises:
finding out a bad credit record from the user records of all the users in the region where the user locates; and
calculating the security factor of the region where the user locates according to the found bad credit record.

5. The method according to claim 3, wherein the calculating the security factor of the region according to the user records of all the users in the region comprises:
finding out a bad credit record from the user records of all the users in the region where the user locates; and
calculating the security factor of the region where the user locates according to the found bad credit record.

6. The method according to claim 4, wherein the calculating the security factor of the region where the user locates according to the found bad credit records comprises:
acquiring recording time of each of the bad credit records;
determining a coefficient corresponding to the recording time of the bad credit record, wherein the coefficient corresponding to the recording time changes from small to big as the recording time is closer to current time; and
calculating a sum of the coefficients corresponding to the recording time of the found bad credit records to obtain the security factor of the region where the user locates.

7. The method according to claim 5, wherein the calculating the security factor of the region where the user locates according to the found bad credit records comprises:
acquiring recording time of each of the bad credit records;
determining a coefficient corresponding to the recording time of the bad credit record, wherein the coefficient corresponding to the recording time changes from small to big as the recording time is closer to current time; and
calculating a sum of the coefficients corresponding to the recording time of the found bad credit records to obtain the security factor of the region where the user locates.

8. The method according to claim 1, wherein the acquiring the user record of the user comprises:
when receiving a security assessment request sent by a user, acquiring the user record of the user, the security assessment request being for acquiring the level of security of the region where the user locates.

9. The method according to claim 1, further comprising:
generating the user record of the user.

10. The method according to claim 9, wherein the generating the user record of the user comprises:
acquiring user information of the user, the user information comprising an identity, position information, and time corresponding to the position information of the user;
querying credit information of the user from a credit server according to the identity of the user; and
generating the user record according to the identity, the position information, the time corresponding to the position information and the credit information of the user, the recording time in the user record being the time corresponding to the position information.

11. A device for security assessment, comprising:
a processor; and
a memory for storing instructions executable by the processor;
wherein the processor is configured to:
acquire a user record of a user, the user record comprising an identity, position information, recording time and credit information of the user;
determine a region where the user locates according to the position information in the user record;
acquire user records of all users in the region;
calculate a level of security of the region according to the user records of all the users in the region; and
send the level of security to the user.

12. The device according to claim 11, wherein the processor is further configured to:
calculate a security factor of the region according to the user records of all the users in the region, the security factor being for characterizing the level of security of the region;
sort the security factor of the region and security factors of a plurality of preset regions in a descending order, the plurality of preset regions being regions within a preset range of the region where the user locates;
when the security factor of the region where the user locates is one of the top N security factors, determine that the security factor of the region where the user locates is low; and
when the security factor of the region where the user locates is one of the last M security factors, determine that the security factor of the region where the user locates is high, M and N being positive integer.

13. The device according to claim 11, wherein the processor is further configured to:
calculate the security factor of the region according to the user records of all the users in the region, the security factor being for characterizing the level of security of the region;
when the security factor of the region is greater than a preset value, determine that the level of security of the region is low; and
when the region of security factor is less than or equal to the preset value, determine that the level of security of the region is high.

14. The device according to claim 12, wherein the processor is further configured to:
find out a bad credit record from the user records of all the users in the region where the user locates; and
calculate the security factor of the region where the user locates according to the found bad credit record.

15. The device according to claim 13, wherein the processor is further configured to:
find out a bad credit record from the user records of all the users in the region where the user locates; and
calculate the security factor of the region where the user locates according to the found bad credit record.

16. The device according to claim 14, wherein the processor is further configured to:
acquire recording time of each of the bad credit records;
determine a coefficient corresponding to the recording time of the bad credit record, wherein the coefficient corresponding to the recording time changes from small to big as the recording time is closer to current time; and
calculate a sum of the coefficients corresponding to the recording time of the found bad credit records out to obtain the security factor of the region where the user locates.

17. The device according to claim 15, wherein the processor is further configured to:
acquire recording time of each of the bad credit records;
determine a coefficient corresponding to the recording time of the bad credit record, wherein the coefficient corresponding to the recording time changes from small to big as the recording time is closer to current time; and
calculate a sum of the coefficients corresponding to the recording time of the found bad credit records out to obtain the security factor of the region where the user locates.

18. The device according to claim 11, wherein the processor is further configured to:
when receiving a security assessment request sent by a user, acquire the user record of the user, the security assessment request being for acquiring the level of security of the region where the user locates.

19. The device according to claim 11, wherein the processor is further configured to:
generate the user record of the user.

20. The device according to claim 19, wherein the processor is further configured to:
acquire the user information of the user, the user information comprising an identity, position information, and time corresponding to the position information of the user;
query credit information of the user from a credit server according to the identity of the user; and
generate the user record according to the identity, the position information, the time corresponding to the position information and the credit information of the user, the recording time in the user record being the time corresponding to the position information.

21. A non-transitory readable storage medium comprising instructions, executable by a processor in a server or a base station, for performing a method for security assessment, the method comprising:
acquiring a user record of a user, the user record comprising an identity, position information, recording time and credit information of the user;
determining a region where the user locates according to the position information in the user record;
acquiring user records of all users in the region;
calculating a level of security of the region according to the user records of all the users in the region; and
sending the level of security to the user.
